(19) United States
(12) Patent Application Publication
(10) Pub. No.: US 2022/0290006 A1
(43) Pub. Date: Sep. 15, 2022

(54) Biodegradable microporous coating

(71) Applicants: Regents of the University of Minnesota, Minneapolis, MN (US); TECHNISCHE HOCHSCHULE KÖLN, Köln (DE)

(72) Inventors: Eric Singsaas, Duluth, MN (US); Timothy Hagen, Superior, WI (US); Stéphan Barbe, Cologne (DE)

(21) Appl. No.: 17/632,294

(22) PCT Filed: Aug. 6, 2020
(86) PCT No.: PCT/US2020/045216

§ 371 Date: Feb. 2, 2022

Related U.S. Application Data
(60) Provisional application No. 62/883,969, filed on Aug. 7, 2019.

(51) Int. Cl. C09D 197/00; C09D 7/20; C05G 5/30; C05B 1/02

(52) U.S. Cl. CPC C09D 197/005; C09D 7/20; C05G 5/30; C05B 1/02

(57) ABSTRACT

A coating for a water-soluble granule comprises a solubilized organosolv lignin as a component for the purpose of limiting the transport of fertilizer through the coating wherein the coating biodegradable. A microporous biodegradable coating includes a blend of an organosolv lignin and cellulous acetate.

### BACKGROUND

The present disclosure relates to coatings for water soluble granules, and in particular to biodegradable and microporous coatings.

To improve the efficiency of fertilizer application to plants, coatings have been applied to the fertilizer granules to release the fertilizer more slowly to the soil. These slow release fertilizer formulations are also referred to as controlled-release. Such coatings limit the transport of fertilizer through the coating wall to the environment and to the plant by imposing a barrier that limits fertilizer transport thereby eliminating a spike of fertilizer.

One advantage of a coated fertilizer granule is that the coated fertilizer can be applied to the field in one application, which saves labor and fuel costs. Furthermore, such coatings prevent a spike of fertilizer being released to the environment upon application of the fertilizer and instead provide a steadier release providing the necessary nutrients to a plant over a longer period of time. Most uncoated fertilizers dissolve quickly when applied to soils and so applying uncoated fertilizer can result in an uncontrolled release or a surge of the fertilizer concentration in the soil. A spike of fertilizer can result in damage to crops due to over absorption of the fertilizer by the plant. In addition, fertilizer not absorbed by the plant will be washed away as runoff into streams and lakes or will leach through the soil and contaminate the groundwater.

Typical fertilizer coatings that exist today are made of a synthetic polymer. For the most part, synthetic polymers are biologically inert and not susceptible to breaking down after the coated fertilizer granule has been spent. The leftover synthetic polymer then contributes to plastic pollution in the environment.

### SUMMARY

This disclosure describes a coating for a water-soluble granule comprising a solubilized organosolv lignin as a component of the coating for the purpose of limiting the transport of fertilizer through the coating.

In another aspect, the coating further comprises cellulous acetate.

In another aspect, the coating is formulated in a dual-solvent system that comprises acetone and water.

In another aspect, ratio of water to acetone controls the porosity of the coating.

This disclosure also describes a method of making a coating for a granule wherein the method comprises solubilizing an organosolv lignin in a solvent.

In another aspect, the method further comprises solubilizing cellulose acetate in a solvent and blending the solubilized cellulose acetate with the organosolv lignin to form a first blended solution of cellulose acetate and organosolv lignin.

In another aspect, the solvent is acetone.

In another aspect, the method further comprises adding water to the blended solution of cellulose acetate and organosolv lignin to form a second blended solution of cellulose acetate and organosolv lignin.

In another aspect, the method further comprises applying the second blended solution of cellulose acetate and organosolv lignin to the granule.

In another aspect, the granule of the method comprises a fertilizer, a insecticide, an herbicide, a water treatment chemical, or a road de-icing chemical.

In another aspect, the granulated fertilizer comprises urea, ammonium nitrate, ammonium phosphates, ammonium sulfate, calcium nitrate, calcium cyanamide, sodium nitrate, calcium phosphates, single superphosphate, triple superphosphate, potassium nitrate, or potassium sulfate or combinations thereof.

In another aspect, of the method the second blended solution of cellulose acetate and organosolv lignin is permitted to dry on the granule and the coating formed after drying is microporous.

In another aspect, of the method porosity of the coating is controlled by the ratio of water to acetone.

This disclosure also describes a coated granule comprising a coating with an organosolv lignin.

In another aspect of the coated granule the coating further comprises cellulose acetate.

In another aspect of the coated granule the coating is the product of a mixture of acetone, water and the cellulose acetate and organosolv lignin.

In another aspect of the coated granule the porosity of the coating is a function of the ratio of acetone to water.

In another aspect of the coated granule, the granule comprises a granulated fertilizer, a granulated insecticide or herbicide, a granulated water treatment chemical or a granulated road de-icing chemical.

In another aspect of the coated granule, the granulated fertilizer comprises urea, ammonium nitrate, ammonium phosphates, ammonium sulfate, calcium nitrate, calcium cyanamide, sodium nitrate, calcium phosphates, single superphosphate, triple superphosphate, potassium nitrate, or potassium sulfate or combinations thereof.

### BRIEF DESCRIPTION OF THE DRAWINGS

FIG. 1A is a scanning electron micrograph of fertilizer granules having homogeneous 100% lignin coating.

FIG. 1B is a scanning electron micrograph of fertilizer granules having porous cellulouse acetate-lignin coating.

FIG. 1C is a scanning electron micrograph of untreated fertilizer granules.

FIG. 2 is a graphical view of the release of fertilizer over time of uncoated and coated fertilizer granules.

### DETAILED DESCRIPTION

This disclosure relates to a coating made from natural materials such as lignin and cellulose acetate, each of which is biodegradable. Lignin and cellulose acetate are plant sourced materials. The lignin, furthermore, biodegrades slowly into the soil which contributes to the slow turnover carbon pool in the soil.

Cellulose acetate as described herein is the acetate ester of cellulose. Cellulose is the main constituent of plant cell walls and of vegetable fibers. Chemically it is a polysaccharide consisting of chains of glucose monomers and thus it is considered a natural polymer.

Lignin is a natural plant-based polymer which binds plant cell fibers and vessels. Lignin as compared to cellulose and cellulose acetate is more difficult to biologically breakdown. It is less hydrophilic than cellulose/cellulose acetate.

The lignin used to produce the coating described herein is an organosolv lignin. An organosolv lignin is extracted via what is commonly known as an organosolv process that extracts the lignin with a solvent under heat and pressure. The solvent may be comprised of alcohols, aldehydes, esters, ethers, alkanes, alkenes, or a mixture thereof. The lignin of this disclosure is in contrast to lignins produced by what is commonly known as the kraft or sulfite pulping process that removes lignin from cellulose fibers by treatment with sodium hydroxide, sodium sulfide, or salts of sulfuric acid as a predicate to papermaking. Such lignin is not suitable for the coating of this disclosure without chemical modification or derivatization.

When the lignin and cellulose acetate of this disclosure are blended together as described further, a polymer blend results. As the term “polymer blend” is used herein, it is a physical mixture of the two polymers, lignin and cellulose acetate.

When applied the polymer blend dries, a microporous coating results that can be used to coat granulated fertilizers and other granulated materials to control water penetration and product dissolution. The coating is prepared in a liquid solvent and can be sprayed onto a surface or onto granules/pellets, agglomerated or not. The coating is comprised of 100% bio-based materials that are biodegradable in soil. As discussed further herein, the coating provides a timed release of the components of the granule due to its biodegradability over time.

The coating of this disclosure can be applied to any surface or granule that would benefit from a natural, biodegradable, microporous coating. In particular, the coating is most suitable for a water-soluble granule. An exemplary list of such applications includes but is not limited to agricultural and landscape granulated fertilizers, granulated insecticides and herbicides, granulated water treatment chemicals granulated road de-icing chemicals and biochar. The biochar may also be included in the coating. An exemplary list of surface applications includes but is not limited to paper, molded wood pulp, nonwoven or woven fabrics, and wood products. Standard fertilizer materials can include urea, ammonium nitrate, ammonium phosphates, ammonium sulfate, calcium nitrate, calcium cyanamide, sodium nitrate, calcium phosphates, single superphosphate, triple superphosphate, potassium nitrate, and potassium sulfate.

The following example(s) is provided solely for illustrative purposes and is not intended to limit the patent claims herein after appended.

### Example

Materials Used:
Acetone (technical grade)
Deionized water
Lignin Attis Innovations, Wausau, Wis., USA
Cellulose acetate (CA) (L50, Daicel Corporation, Mn˜107000 with an acetylation degree of approximately 55%
Fertilizer: Superphosphate 18

Methods:

### 1. Preparation of a Polymer Solution for Homogeneous 100% Lignin Coating

Approximately 30 grams of lignin was mixed at room temperature in approximately 470 grams of acetone under reflux for approximately 24 hours to produce a homogeneous lignin solution

### 2. Preparation of a Polymer Blend Solution to Produce a Porous Cellulouse Acetate-Lignin Coating

Approximately 37.5 grams of cellulouse acetate was mixed with approximately 375 grams acetone at room temperature under reflux for approximately 24 hours. Approximately 12.5 grams of lignin was then added to the mixture and the mixture was stirred for approximately 24 hours. Lastly, approximately 74 grams of water was carefully added drop wise into the solution and the solution was mixed for at least approximately 24 hours.

The addition of water allows for the formation of the microporous structure. The water becomes a co-solvent with the acetone in a two-solvent system that holds the cellulous acetate and lignin in solution. The cellulous acetate and lignin are most soluble in pure acetone and insoluble in pure water. Their solubility decreases as the ratio of acetone:water declines. Because acetone evaporates quickly this causes a steadily decreasing acetone:water ratio that reaches a point where the polymer begins to drop out of solution to create a coating. Residual acetone in the polymer coating that deposits on a surface evaporates from it in a semi-solid state, creating micropores in the coating.

One important aspect of this disclosure will be that the porosity of the coating can be controlled by manipulating the water:acetone ratio. Other co-solvents with acetone such as butyl acetate, butanol, ethanol, and ethyl acetate may also be used. Water is the most desirable since it is the cheapest and least toxic of the mentioned co-solvents.

Preparation of Coated Fertilizers

Fertilizer granules were placed on a tray and each of the above coatings was applied with a paint gun. The tray was manually shaken in order to achieve a homogenous coating on the fertilizer granules

Measurement of Fertilizer Release

To comparatively measure fertilizer release, 1 gram of untreated fertilizer granules and each of the coated fertilizer granules were added to 500 mL of deionized water and

electric conductivity was monitored over time. The suspension was vigorously agitated by means of a magnetic stirrer during the measurement of fertilizer release.

Results

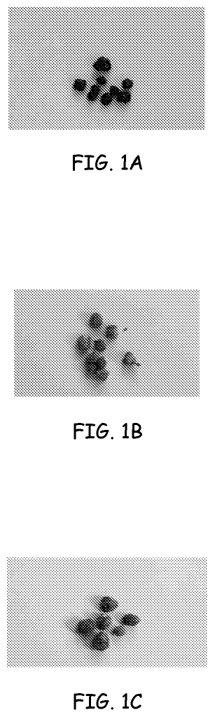

FIG. 1 which is a photographic view shows the untreated fertilizer granules and each of the coated fertilizer granules of this example. Visually, the coated granules appear to be satisfying and a porous layer can be observed in the granules coated with the lignin-cellulose acetate blend.

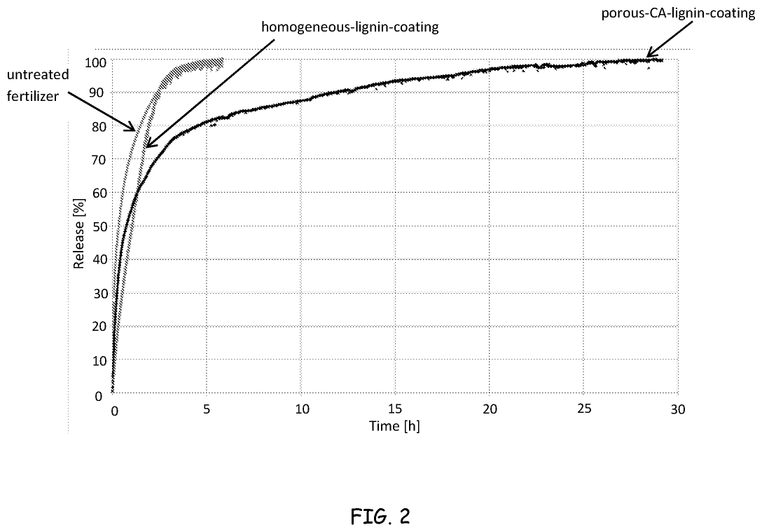

The evolution of fertilizer release was measured by submersion of the fertilizer in deionized water. Fertilizer salt release is depicted on FIG. 2 as percent (%) release over time for the untreated fertilizer granules (red) granules coated with ony lignin (gray) and fertilizer coated with the cellulose-acetate lignin blend (black). It is important to note that the release condition applied in this example is by far much more efficient than the release which would occur in soil. Release delay measured with the presented technique may be much longer under real (soil) conditions. During the measurement, the pH value dropped from 7 to 4.5 due to acidity of the salt, which could increase the rate of fertilizer release. Surprisingly, only a slight release delay was observed with the homogeneous 100% lignin coating which may result from the lignin coating dissolving in the water. An appreciable release delay was measured with the porous lignin/cellulose acetate coating. In the porous lignin/cellulose acetate coating, total release was achieved after approximately 30 hours; approximately 6 times longer than the uncoated granules.

1. A coating for a water-soluble granule comprising a solubilized organosolv lignin as a component for the purpose of limiting the transport of fertilizer through the coating.

2. The coating of claim 1 and further comprising cellulose acetate.

3. The coating of claim 2 and further comprising acetone.

4. The coating of claim 3 and wherein water is used to produce the coating and the ratio of water:acetone controls the porosity of the coating.

5. A method of making a coating for a granule that comprises initially solubilizing an organosolv lignin in a solvent.

6. The method of claim 5 and further comprising solubilizing cellulose acetate in a solvent and blending the solubilized cellulose acetate with the organosolv lignin to form a first blended solution of cellulose acetate and organosolv lignin.

7. The method of claim 6 wherein the solvent is acetone.

8. The method of claim 6 and further comprising adding water to the blended solution of cellulose acetate and organosolv lignin to form a second blended solution of cellulose acetate and organosolv lignin.

9. The method of claim 8 and further comprising applying the second blended solution of cellulose acetate and organosolv lignin to the granule.

10. The method of claim 1 wherein the granule comprises a granulated fertilizer, a granulated insecticide or herbicide, a granulated water treatment chemical or a granulated road de-icing chemical.

11. The method of claim 10 wherein the granulated fertilizer comprises urea, ammonium nitrate, ammonium phosphates, ammonium sulfate, calcium nitrate, calcium cyanamide, sodium nitrate, calcium phosphates, single superphosphate, triple superphosphate, potassium nitrate, or potassium sulfate or combinations thereof.

12. The method of claim 8 wherein the second blended solution of cellulose acetate and organosolv lignin is permitted to dry on the granule and the coating formed after drying is microporous.

13. The method of claim 12 wherein porosity of the coating is controlled by the ratio of water to acetone.

14. A coated granule comprising a coating with an organosolv lignin.

15. The coated granule of claim 14 wherein the coating further comprises cellulous acetate.

16. The coated granule of claim 14 wherein the coating is the product of a mixture of acetone, water and the cellulose acetate and organosolv lignin.

17. The coated granule of claim 16 where porosity of the coating is a function of the ratio of acetone to water.

18. The coated granule of claim 14 wherein the granule comprises a granulated fertilizer, a granulated insecticide or herbicide, a granulated water treatment chemical or a granulated road de-icing chemical.

19. The coated granule of claim 18 wherein the granulated fertilizer comprises urea, ammonium nitrate, ammonium phosphates, ammonium sulfate, calcium nitrate, calcium cyanamide, sodium nitrate, calcium phosphates, single superphosphate, triple superphosphate, potassium nitrate, or potassium sulfate or combinations thereof.
